(19) United States
(12) Patent Application Publication
(10) Pub. No.: US 2005/0201332 A1
(43) Pub. Date: Sep. 15, 2005

(54) Link quality control in a wireless communications network

(76) Inventors: Rakesh Bakshi, Bridgewater, NJ (US); Asif Gandhi, Iselin, NJ (US); Charles Albert Sanders, Bridgewater, NJ (US); Susan Wu Sanders, Bridgewater, NJ (US); Mathew Thomas, Madison, NJ (US)

Correspondence Address: HARNESS, DICKEY & PIERCE, P.L.C., P.O. Box 8910, Reston, VA, 20195, US

(21) Appl. No.: 10/799,727

(22) Filed: Mar. 15, 2004

(51) Int. Cl. H04Q 7/00

(52) U.S. Cl. 370/333; 370/332

(57) ABSTRACT

A method for link quality control in a wireless communications network includes determining whether an indicator of link imbalance exists among a plurality of base stations associated with a mobile unit, and implementing a control action to help prevent at least one of fading or signal cutoff between the mobile unit and at least one of the base stations, if the indicator indicates that link imbalance exists.

### BACKGROUND OF THE INVENTION

A mobile unit in a wireless communication network is often connected to more than one base station during normal operation. In each connection between each base station and the mobile unit, a forward link and a reverse link are set up to exchange information including mobile user communications and power adjustment information. At any given time, each of the links may have different strengths of quality. Where link quality is good, the link is said to be strong. Where link quality is poor, the link is said to be weak. An example of such a configuration is shown in FIG. 1.

FIG. 1 is a simplified schematic illustration of a balanced telecommunications network. In FIG. 1, mobile unit 130 communicates with base station A 110 over a strong forward link 112 and a strong reverse link 114. Mobile unit 130 also communicates with base station B 120, but over a weak forward link 122 and weak reverse link 124. The forward link quality information is made available to a base station controller (BSC) 140. Base station A 110 and base station B 120 communicate with the BSC 140, which provides base stations A and B 110, 120 with control information.

Using the forward links 112, 122, the base stations A and B 110, 120 provide the mobile unit 130 with power adjustment information in the form of power control bits (PCBs). The PCBs are independently produced by each BS in order to control the reverse link signal quality at each BS. The mobile unit 130 increases power if and only if all of the base stations A and B 110, 120 indicate that power should be increased; otherwise, the power is decreased. Likewise, using the reverse links 114, 124, the mobile unit 130 provides the base stations 110, 120 with PCBs. This is to adjust the forward transmit power so that the forward link quality can be maintained. Note that in this example, the forward power control adjustments are determined by the mobile based on the aggregate forward link signal from all base stations in handoff. The base stations A and B 110, 120 use the PCBs sent from the mobile unit to adjust their forward link power as indicated by the mobile unit 130.

Strong links between the mobile unit 130 and the base stations A and B 110, 120 help ensure that power adjustment commands are effectively sent between the mobile unit 130 and the base stations 110, 120. The configuration shown in FIG. 1, where a strong forward link 112 and strong reverse link 114 are used between one base station 110 and the mobile unit 130, is what is known as link balance. Link balance aids in the quality of mobile communication because it helps ensure the integrity of power adjustment signals and that the power adjustment signals are received by the appropriate recipients.

Soft handoff links are termed imbalanced when a mobile unit receives information over a strong forward link from a first base station while the strongest reverse link is received by a second base station. An example is shown in FIG. 2.

FIG. 2 is an illustrative representation of an unbalanced telecommunications network. In FIG. 2, the mobile unit 130 communicates with base station A 110 over a strong forward link 112 and a weak reverse link 214. Mobile unit 130 also communicates with base station B 120, but over a weak forward link 122 and strong reverse link 224. In this configuration the links are imbalanced. Imbalance may occur during soft hand-offs. When imbalance occurs, power adjustment information may not effectively reach the appropriate controlling base stations. For example, the mobile unit 130 may send power adjustment information over weak reverse link 214 for base station A 110 to boost its strong forward link 112 power. If base station A 110 does not receive this information, base station A 110 may not boost power as requested by the mobile unit 130. Likewise, base station B 120 may send power adjustment information over weak forward link 122 for the mobile unit 130 to reduce its strong reverse link 224 power. If the mobile unit 130 does not receive this information, the mobile unit 130 may not decrease power as requested by base station B 120. Because power adjustments are not properly being received, the mobile unit 130 may not be able to effectively receive communication signals from the base stations A and B 110, 120. Moreover, the base stations may not be able to effectively receive communication signals from the mobile unit 130. As a result, communication with the mobile unit 130 may become distorted and even cut-off.

### SUMMARY OF THE INVENTION

The present invention provides a method for link quality control in a wireless communications network.

According to an example embodiment, a determination is made as to whether an indication of link imbalance exists among a plurality of base stations involved in a soft handoff with a mobile unit. If so, a control action is taken.

In an example embodiment, link imbalance is indicated when a number of reverse power control down bits over an interval of frames at any one sector system (sector) is greater than or equal to a threshold value, where the sector is one of the sectors associated with the base stations involved in a soft handoff with the mobile. The down bits being at or above the threshold_indicates that a strong reverse link is received by the sector, and power control bits to reduce the mobile's transmission power are not adequately delivered via the forward link.

Alternatively, a measured bit energy to noise ratio (Eb/No) for a number of frames minus a global Eb/No setpoint being greater than a threshold value at a sector of at least one of the associated base stations is also an indicative metric. Here, the global setpoint is a predetermined acceptable energy to noise ratio for the mobile unit. Each sector produces a locally measured Eb/No minus a global setpoint that is greater or equal to a threshold value. In this embodiment, the measured received signal quality (Eb/No) exceeds the required global setpoint by a predetermined threshold for a period of time. This indicates that the reverse link is strong on this sector but the power control bits are not being delivered to the mobile station to bring the reverse Eb/No in line with the global setpoint.

In another example embodiment, a sector in soft handoff with the strongest forward link has a short-term local reverse link error rate that is greater than a threshold value, the sector being from at least one of the associated base stations. This scenario indicates that while the forward link is adequately strong, the reverse link quality is unacceptable for reliable communication, indicating imbalance.

In still another example embodiment to help overcome link imbalance, control actions include instructing each associated base station to raise a minimum gain on forward links associated with the mobile unit by a specified increment; instructing at least one of the associated base stations to raise the minimum gain of forward links associated with the mobile unit by a specified interval; and instructing the associated base stations with strong forward links to send power control instructions to increase the mobile transmit power of reverse links received by the associated base stations with strong forward links. The increased mobile power control instructions are sent from each base station simultaneously.

### BRIEF DESCRIPTION OF TIE DRAWINGS

The present invention will become more fully understood from the detailed description given below and the accompanying drawings, wherein like elements are represented by like reference numerals, which are given by way of illustration only and thus are not limiting on the present invention and wherein:

FIG. 1 is a simplified schematic illustration of a balanced telecommunications network;

FIG. 2 is an illustrative representation of an unbalanced telecommunications network;

FIG. 3 illustrates a method to correct an unbalanced telecommunications network according to an exemplary embodiment of the invention;

FIG. 4 illustrates a corrective control action according to an embodiment of the invention;

FIG. 5 illustrates a corrective control action according to an embodiment of the invention; and

FIG. 6 illustrates a corrective control action according to an embodiment of the invention.

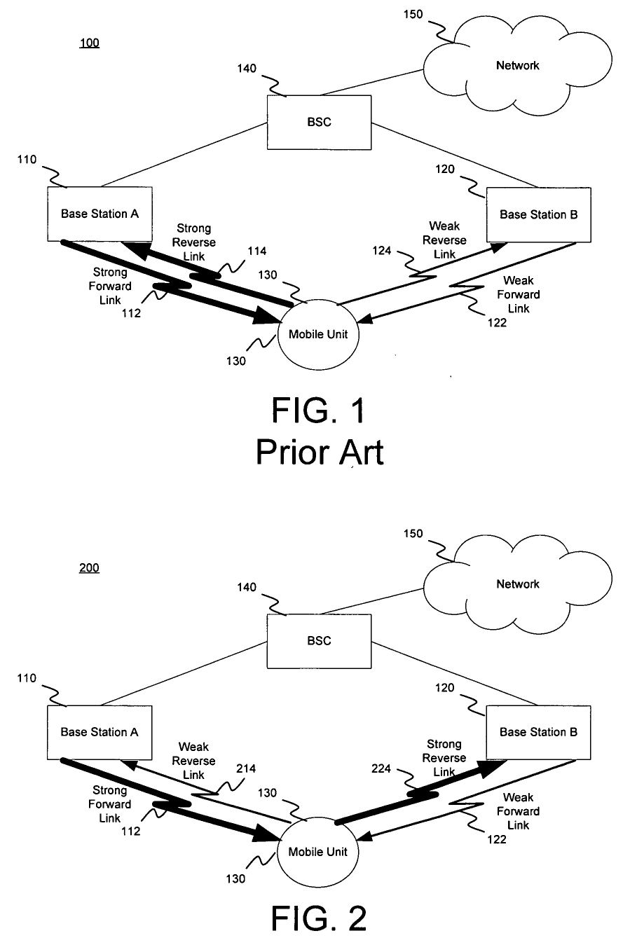

### DETAILED DESCRIPTION OF EMBODIMENTS

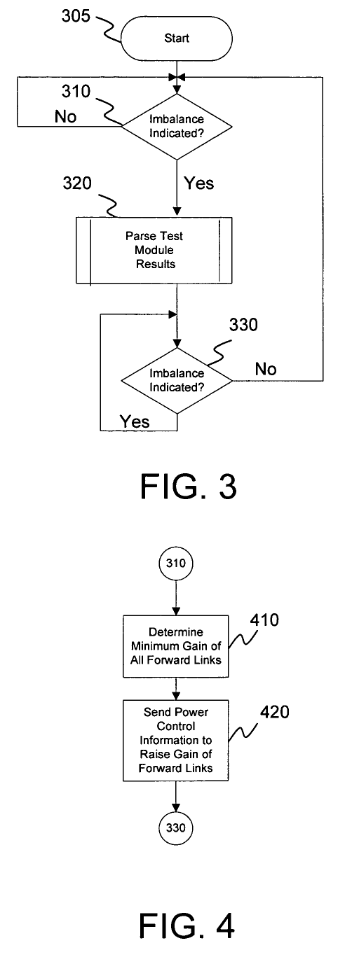

Link imbalance may cause distorted communications and even the cut-off of mobile unit communications. Some of the negative affects of link imbalance can be overcome using embodiments of the invention. FIG. 3 illustrates a method to correct an unbalanced telecommunications network according to an exemplary embodiment of the invention. For the purposes of discussion only, the method of FIG. 3 will be described as employed in the telecommunications network of FIG. 2. An imbalance controller is introduced that employs the method of FIG. 3.

An imbalance controller is software or hardware that may be part of a stand-alone system. The imbalance controller may also be located with a base station or a system that controls base stations, or be divided between both. The imbalance controller determines as shown in FIG. 3 whether imbalance is indicated, a control action to take if imbalance is indicated, and when to stop the control action.

In the example embodiment shown in FIG. 3, the imbalance controller determines whether an indicator of link imbalance exists, step 310, based on measurements made by the mobile station 130. If no indication of imbalance exists, the imbalance controller continues monitoring for imbalance. If an indication of imbalance does exist, the imbalance controller determines a control action to take and executes the control action in step 320. The imbalance controller then makes a determination as to when the control action is no longer needed, step 330. If the control action is still needed, then the imbalance controller waits for a period of time. If the control action is no longer needed, the imbalance controller continues to check for imbalance, step 310. The method can be implemented in software or hardware in a base station, a controller of a base station, or any combination thereof. The following is a detailed discussion of each of the steps 310, 320, 330.

### Determining Whether Link Imbalance is Indicated—Step 310

In an example embodiment, reports from the mobile unit 130 may be used to determine whether link imbalance is indicated. A mobile unit reports forward link quality back to each base station it is in communication with. The base station may send the reports to an associated BSC. Each base station in communication with the mobile unit may also obtain this forward link quality report from an affiliated BSC or frame selector (FS). Forward link and reverse link information is made available to an imbalance controller.

If the imbalance controller detects that a base station is connected via a strong forward link to a mobile unit, but connected via a weak reverse link to the same mobile unit, then the imbalance controller determines link imbalance is indicated. Below is described the forward and reverse link information that is obtained by the imbalance controller.

To help determine a base station's forward link quality, each base station uses reporting information from the mobile unit to which it is communicating. There are several ways for a mobile unit to report forward link quality. For example, the mobile station can send periodic pilot strength measurement messages (PPSMMs) that contain all active pilot energy to total power ratio (Ec/Io) strengths and a corresponding pseudorandom number (PN) offset. PPSMMs are commonly used in code division multiple access (CDMA) systems. This information is made available to the imbalance controller.

In another example, the mobile unit can send over a reverse link a Power Measurement Report Message (PMRM) that is triggered by received forward link frame error counts. PMRMs are commonly used in CDMA systems. The PMRM contains all active Ec/Io strengths and the measured Forward Frame Error Rate (FFER). The ordering of the Ec/Io strengths is determined by the ordering of the respective pilot channels in the handoff messages sent by each base station.

Another way to report forward link quality is to use the reverse link channel quality indicator channel (R-CQICH) defined in the third generation Evolution Data and Voice (3GEV-DV) standard. The R-CQICH reports its strong forward link carrier to interference (C/I) value and a distinct Walsh cover for a particular pilot.

There are also several ways to determine reverse link quality. One example is using an echoed reverse link energy per bit to noise density ratio (Eb/No) setpoint from the BSC or FS to compare with its local measured Eb/No. If the echoed Eb/No setpoint is smaller than its local measured Eb/No by a predetermined margin specified at the base station, a weak reverse link is indicated. Another example is to use a reverse link frame error rate (FER) or symbol error rate (SER) measurement as criteria.

The above metrics may be used to obtain forward link and reverse link information, which may then be used in determining imbalance. Some specific ways of determining imbalance are now provided.

For example, if the number of reverse power control (RPC) down bits over an amount of frames (e.g., 3 frames) at any one sector is greater than or equal to a threshold value (e.g., 32 or 40), the imbalance controller determines that the possibility of link imbalance exists. The threshold value is determined based on normal operations of a particular sector. Where excessive RPC down bits are sent beyond a normal amount of down bits for the sector, imbalance is possible. Imbalance is possible because the excessive amount of correction to power levels downward could be indicating that the intended recipient of the down bits is not receiving them, thus, power output is maintained at unacceptable levels.

Alternatively, if the Eb/No for a set number of frames (e.g. 5 frames) is valid and the measured Eb/No—global setpoint is greater than a predetermined value (e.g. 2.5 dB) at any sector, that is also an indicator of link imbalance. This is an indicator that the reverse link is received much stronger than required for reliable communication, but that the RPC bits are not reaching the mobile station. A global setpoint is an acceptable Eb/No for a particular mobile system. Where the Eb/No for a set number of frames is significantly above the global setpoint, it is likely that power level adjustments are not properly being communicated.

Moreover, if at a sector with a strongest forward link, the local setpoint—global setpoint is greater than or equal to a threshold value (e.g., 1.5 or 2.0 dB), that is a sign of imbalance. A local setpoint is determined locally by a base station based on Eb/No over a particular length of time. Where a local set-point is significantly above the global set-point, it is likely that power level adjustments are not properly being communicated between a mobile and the base station. Such a lack of communication should not occur, but for imbalance, because of the ability of the base station to communicate its power control requests over its strong forward link.

Furthermore, if a sector with a strongest forward link has a short-term local reverse link frame error rate (FER) that is greater than a threshold percentage (e.g., 25%), which is also taken as a sign of imbalance. Where a short-term local reverse link FER is significantly high, it is likely that power level adjustments are not properly being communicated between a mobile and the base station. This is so, except for the case that the mobile is at its maximum transmit power. Such a lack of communication should not occur, but for imbalance, because of the ability of the base station to communicate its power control requests over its strong forward link.

In this embodiment, it is a function of the imbalance controller to collect the aforementioned forward and reverse link metrics and to correlate on a sector-by-sector basis the relevant quality metrics for corresponding forward and reverse links. The imbalance controller declares an imbalance condition exists if it determines that a given sector corresponds to a strong forward link and weak reverse link or vice-versa.

While in the above example embodiment, a base station makes the determination as to whether an indication of imbalance is present, the determination may also be made by a base station controlling system such as a BSC. The BSC may determine whether a link imbalance is indicated using information supplied to it by base stations. Moreover, the determination of whether link imbalance is indicated may be divided between a base station and BSC.

### Determining and Executing a Control Action—Step 320

In an example embodiment, when a link imbalance is indicated, step 310, the imbalance controller initiates a corrective control action.

FIG. 4 illustrates a corrective control action according to an exemplary embodiment of the invention. FIG. 4 shows a corrective control action taken by the imbalance controller that includes sending control information to base stations to raise minimum gains on all forward links. Once an imbalance is detected, step 310, a corrective control action is taken, step 320. To raise the minimum gain on all forward links, the amount to raise the gain of all forward links is determined, step 410. The minimum gain, for example, may be raised to a specific value such as −5 dBp. Another variant is to raise the minimum gain for each forward link by a predetermined amount. In other words, the new minimum gain would be the old minimum gain plus the predetermined amount. For example, the predetermined amount could be 3dB or more. In both scenarios, the specific value or raised amount can be either fixed or adjusted according to frame error rate feed back. After the amount to raise the gain of all forward links has been determined, step 410, power control information reflecting the gain adjustment is sent to each of the base stations communicating with the mobile unit, step 420. As a result, each of the forward links is raised sufficiently so that the mobile unit can more effectively receive power adjustment information from each of the forward links. This corrective control action continues until a determination is made that a control action is no longer needed, step 330. While the gain of all forward links are raised in the above example embodiment, one skilled in the art will recognize that less than all the gains of the forward links may be adjusted and still obtain the benefits of the invention.

In addition to increasing the minimum gains of the forward links, this corrective action may also include boosting the power allocated to the power control bits on the forward link channel. This improves the likelihood that the power control instructions will be successfully delivered to the mobile station when an imbalance condition exists.

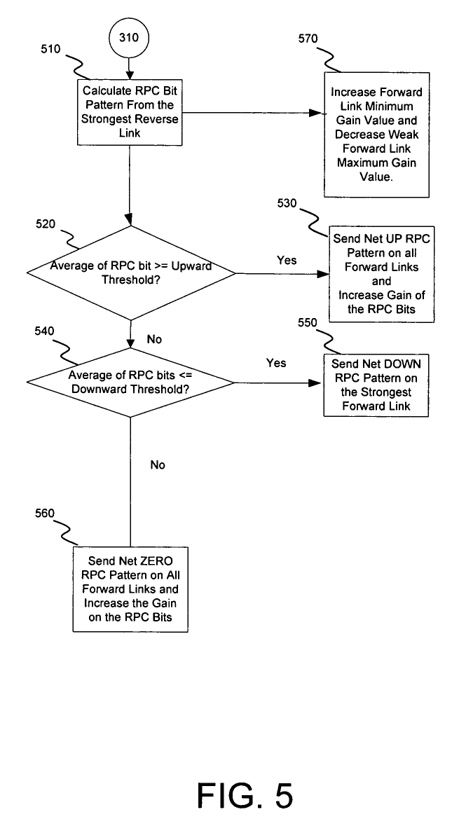

FIG. 5 illustrates a corrective control action according to another example embodiment of the invention. As shown, BSC 140 increases the forward link minimum gain value and decreases the weak forward link maximum gain values in step 570. Additionally, the BSC 140 calculates the net power control instructions from the strongest reverse link in step 510. The calculation may include deriving the reverse power control (RPC) bits also known as the reverse link inner loop power control (RILPC) bits, from the strongest reverse link and finding a net value of the RPC bits, which are transmitted over the forward link over an amount of frames, to obtain a net power control adjustment value. For example, where the RPC bits indicate 10up and 6dn, the net power control adjustment value would be 4 up.

If the RPC bits from the strongest reverse link indicate an average net value (e.g., up 7) greater than or equal to an upward power control adjustment threshold value (e.g., up 6), step 520, then the reverse link power adjustment information (e.g., the RPC bit pattern sent on the forward link) is sent from the imbalance controller with a minimal up pattern to the base stations controlling all the forward links, step 530. In addition, the power used to send the RPC bits on the weak forward links needs to be increased. If the RPC bits are punctured on the forward traffic channel, raising the minimum gain on the forward traffic channel helps in sending the RPC bits. The RPC bits can also be sent on an associated forward common power control channel (F-CPCCH) F-CPCCH which provides an enhanced freedom to set the power to send the RPC bits. The minimal up pattern may be a number of up commands that are known or have been shown to correct imbalance in the past (e.g., 2 up).

If the RPC bits from the strongest reverse link indicates an average net value (e.g., down 7) less than a downward power control adjustment threshold value (e.g., down 6), step 540, the imbalance controller sends power adjustment with a net minimal down pattern to the base stations controlling the strong forward links, step 550. The minimal down pattern may be a number of down commands that are known or have been shown to correct imbalance in the past (e.g., 2 down). This allows the strong forward links to replace RPC bits requesting a power decrease that may not be received on its weak reverse link, because of an imbalance, for the mobile station to reduce power.

Otherwise, an RPC bit pattern is received by the base stations controlling all forward links with a net zero pattern and the gain on the RPC bits is increased, step 560.

As for the control of power on the forward links, the traffic power is adjusted to a low value (e.g., −15 dBp) for the weak forward links. One way to do this is to pull down the maximum gain setting for the weak links. This has an effect of forcing the weak forward links not to waste their power as they have little, if any, influence on a mobile units communications. Additionally, the minimum gains for the strong forward links can be pulled up to a higher value to preserve the overall forward link integrity.

An outcome of this embodiment is that the strongest forward links are power adjusted and the weak forward links are set to a low value. Moreover, the reverse link power is also adjusted.

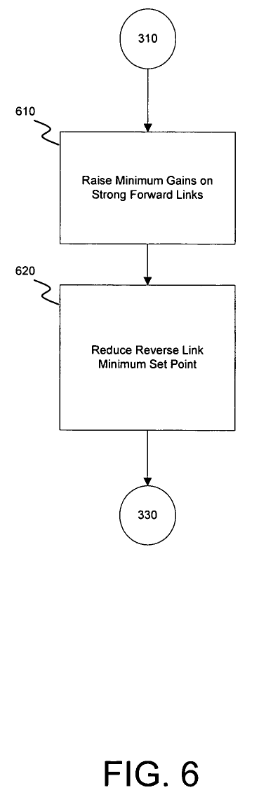

FIG. 6 also illustrates a corrective control action according to a still further exemplary embodiment of the invention. As shown in FIG. 6, a corrective control action includes increasing the minimum gains on all forward links to a fixed or calculated, step 610.

For the reverse links, during the period of imbalance, the minimum setpoint on the reverse link is reduced by a specified value (e.g., a value of 3 to 5 db) from the nominal value, step 620. The minimum setpoint establishes the minimal mobile signal quality. Reduction of the minimum set point helps pull the strong reverse link down and reduce the capacity impact. Also, after an imbalance is detected and a strong reverse link measured Eb/No which far exceeds the maximum setpoint is detected, the setpoint can be lowered in an ad-hoc manner, or the power control system for the base station can lower the set point. If errors occur on the reverse link, or imbalance is no longer present, the outer-loop setpoint is brought back to default values. The corrective control action continues until a determination is made that a control action is no longer needed, step 330.

While individual options are shown in FIGS. 4-6, it is possible that one can “mix-and-match” the forward link options shown in FIGS. 4-6 with the reverse link options shown in FIGS. 4-6 (e.g., implement forward link corrective actions of FIG. 5 with the reverse link corrective actions of FIG. 6, etc.)

### Determining That Control Action is No Longer Needed—Steps 330

Two example methods to determine when a control action is no longer needed, step 330, will now be described. In the first method, the control action may continue until a handoff occurs. In a second method, the control action may be maintained for a fixed period of time (e.g., 2 seconds). The fixed period is determined based on the length of time needed to generate a forward link report (e.g., PMRM report) and determine whether a detrimental link imbalance indicator is still present. The fixed period used should be greater than the time it takes for a PMRM report to be generated and processed. Waiting a time greater than the report generation and processing time of the report, helps ensure that the control action will continue until the indication of link imbalance is determined, step 310. During the waiting period, a new control action may be invoked, replacing the older control action. In other words, the imbalance controller may receive further information that the imbalance controller determines, step 310, is an indication of imbalance and needs corrective action is still present and that another control action needs to be taken, step 320.

The invention being thus described, it will be obvious that the same may be varied in many ways. For example, while the embodiments of the present invention were described with respect to a link imbalance indication, it will be appreciated that the present invention is equally applicable to synchronizing links where link imbalance is not necessarily present. Such variations are not to be regarded as a departure from the spirit and scope of the invention, and all such modifications as would be obvious to one skilled in the art are intended to be included within the scope of the present invention.

1. A method for link quality control in a wireless communications network comprising:
determining whether an indicator of link imbalance exists among a plurality of base stations associated with a mobile unit, and
implementing a control action to help prevent at least one of fading or signal cutoff between the mobile unit and at least one of the base stations, if the indicator indicates that link imbalance exists.

2. The method of claim 1, wherein the determining step includes receiving base station forward link information and base station reverse link information of the associated base stations regarding the mobile unit.

3. The method of claim 1, wherein the determining step further includes determining that an indicator of link imbalance exists when a number of reverse power control down bits over an amount of frames at any one sector is one of greater than and equal to a threshold value, the any one sector being from one of the associated base stations.

4. The method of claim 1, wherein the determining step further includes determining that an indicator of link imbalance exists when an energy to noise ratio for a number of frames minus a global set-point is greater than a threshold value at a sector of the associated base stations, the global set-point being an acceptable energy to noise ratio for the mobile unit.

5. The method of claim 1, wherein the determining step further includes determining that an indicator of link imbalance exists when a sector has a local set-point minus a global set-point that is one of greater than and equal to a threshold value, a local set-point being determined locally by one of the associated base stations based on a signal to noise ratio, a global set-point being an acceptable energy to noise ratio for the mobile unit, the sector being from at least one of the associated base stations with a strongest forward link.

6. The method of claim 1, wherein the determining step further includes determining that an indicator of link imbalance exists when a sector with a strongest forward link has a short-term local reverse link error rate that is greater than a threshold value, the sector being from at least one of the associated base stations.

7. The method of claim 1, wherein the control action includes instructing each associated base station to raise a minimum gain on forward links associated with the mobile unit to a specified level.

8. The method of claim 1, wherein the control action includes instructing at least one of the associated base stations to raise the minimum gain of forward links associated with the mobile unit by a specified interval.

9. The method of claim 1, wherein the control action includes instructing the associated base stations with strong forward links to send reverse power control bits based on the strongest reverse link.

10. The method of claim 1, wherein the control action includes instructing each base station to raise a minimum gain on all strong forward links of the associated base stations to a specified level and setting weak forward links of the associated base stations to a low gain value.

11. The method of claim 1, wherein the control action includes instructing the all the base-stations to adjust a minimum gain set point of the reverse link by a set value from a nominal value.

12. The method of claim 1, wherein the control action includes instructing the associated base stations to raise a minimum gain of all strong forward links by a specified interval and setting weak forward links to a low gain value.

13. The method of claim 1, wherein the control action includes instructing all the base stations to adjust a minimum gain set point of reverse links, associated with the base stations by a set value from a nominal value.

14. The method of claim 1, further comprising determining when to discontinue the control action.

15. The method of claim 15, wherein the determining when to discontinue the control action includes discontinuing the control action when a handoff state changes.

16. The method of claim 16, wherein the determining when to discontinue the control action includes maintaining the control action for a fixed time period.
